(19) United States
(12) Patent Application Publication
(10) Pub. No.: US 2019/0061285 A1
(43) Pub. Date: Feb. 28, 2019

(54) Fibre Composite Component Having An Elastomer Seal And A Method Of Production Thereof

(71) Applicant: Airbus Operations GmbH, Hamburg (DE)

(72) Inventors: Martin Hentschel, Hamburg (DE); Marc Fette, Hamburg (DE); Bernd Ruppert, Hamburg (DE); Alexei Vichniakov, Hamburg (DE)

(73) Assignee: Airbus Operations GmbH, Hamburg (DE)

(21) Appl. No.: 16/114,739

(22) Filed: Aug. 28, 2018

(30) Foreign Application Priority Data
Aug. 30, 2017 (DE) 10 2017 119 933.0

(51) Int. Cl. B29C 70/46; B29C 70/80; B29C 70/74

(52) U.S. Cl. CPC B29C 70/46; B29C 43/04; B29C 70/74; B29C 70/80

(57) ABSTRACT

A method of producing a fibre composite component having an elastomer seal disposed on a top side at the edge in annular manner around an opening, includes: providing a first, laminar semifinished product having fibres preimpregnated with a first thermoset, incompletely crosslinked matrix material; applying a sealing compound to a particular deposition region at a top side of the first semifinished product so as to form a semifinished composite product including the first semifinished product and the sealing compound applied, the sealing compound being formed by an elastomeric semifinished product; and extrusion-forming the semifinished composite product to give the fully crosslinked fibre composite component having the elastomer seal. The fibre composite component results from crosslinking of the first semifinished product, and the elastomer seal from crosslinking of the sealing compound. The fibre composite component and the elastomer seal are cohesively bonded to one another by a common extrusion-forming operation.

### FIELD OF THE INVENTION

The present invention relates to a method of producing a fibre composite component having an elastomer seal and to a fibre composite component having an elastomer seal.

### BACKGROUND OF THE INVENTION

Fibre composite components are basically known from the prior art. Fibre composite components are often produced using thermoset semifinished products. Semifinished products of this kind, in the state prior to processing, generally include an as yet incompletely crosslinked matrix material and fibres. The matrix material permeates, i.e. impregnates, the fibres. The fibres may be in the form of mats or weaves, for example, in the semifinished product. Typical fibres are carbon fibres, glass fibres and aramid fibres. Owing to incomplete crosslinking of the matrix material, such a semifinished product is pliable and can be fitted in terms of its shape. In order to produce a fibre composite component from such a semifinished product, the semifinished product is extrusion-formed to give the fibre composite component. This is typically accomplished with the aid of a shaping structure. The extrusion method can be effected, for example, by a hot pressing method and/or in an autoclave with the aid of pressure and temperature.

Fibre composite components produced in such a way are used in many sectors of industry, especially in the automobile and aviation industry. For example, uses of the fibre composite components in the aviation industry include in aircraft fuselages, cabin linings and fuel tanks, for example in the form of panels. The use of fibre composite components for cabin panels or fuel tank panels frequently gives rise to the necessity of creating passages, for example for holding elements. Passages of this kind frequently have to provide a sealed transition to the element that has been passed through. For this purpose, in the prior art, an elastomer seal is individually fitted during assembly on site and positioned around the holding elements.

However, such an assembly of elastomer seals has the disadvantage that it is time-consuming and personnel-intensive. Owing to the high time demands, this method of providing an elastomer seal, for example in the final assembly of fuel tanks of aircraft, constitutes a disadvantageous bottleneck in the cycle in terms of time and logistics.

### BRIEF SUMMARY OF THE INVENTION

An aspect of the invention may provide a method of producing a fibre composite component that permits particularly precise and simple sealing without high demands.

The method according to an aspect of the invention for producing a fibre composite component having an elastomer seal comprises the steps of:

a) providing a first, laminar semifinished product having fibres preimpregnated with a first thermoset, incompletely crosslinked matrix material;
b) applying a sealing compound to a predetermined deposition region at a top side of the first semifinished product so as to form a semifinished composite product composed of the first semifinished product and the sealing compound applied, the sealing compound being formed by an elastomeric semifinished product;
c) extrusion-forming the semifinished composite product to give the fully crosslinked fibre composite component having the elastomer seal, wherein the fibre composite component results from crosslinking of the first semifinished product, and the elastomer seal from crosslinking of the sealing compound.

First of all, a first semifinished product is thus provided. The first semifinished product may take the form of a laminar first semifinished product. A laminar semifinished product may describe a semifinished product having a thickness several times less than its two-dimensional extent. The first semifinished product may have a layer arrangement having at least one functional layer. A functional layer may be a layer of a fibre-reinforced thermoset matrix material. Thus, the layer arrangement may be formed, for example, by exactly one functional layer or from multiple functional layers. If multiple functional layers are provided, these may be arranged and/or layered one on top of another. Each functional layer may have a fibre-reinforced, thermoset matrix material. The thermoset matrix material as such is incompletely crosslinked and/or incompletely cured. Since the thermoset material as such is as yet incompletely cured or crosslinked but may be partly crosslinked, the fibre-reinforced thermoset material is still formable as desired. Therefore, any functional layer may also be pliable. The thermoset matrix material may be based, for example, on thermosets or thermoset reactive resins, for example unsaturated polyester resins, vinyl ester resins, phenolic resins and/or epoxy resins.

To improve the mechanical properties, a fibre reinforcement of the thermoset matrix material as such is provided. For this purpose, fibres have been embedded into the thermoset matrix material of a functional layer as such. In other words, the fibres have been preimpregnated with the incompletely crosslinked matrix material. For this purpose, it is possible to use, for example, long fibres, short fibres or continuous fibres. In other words, the matrix material for the functional layer may be a long fibre-reinforced thermoset matrix material. It may also be a short fibre-reinforced thermoset matrix material. It may also be a continuous fibre-reinforced thermoset matrix material. If long fibres are used, these can have, for example, an average fibre length between 10 mm and 80 mm, preferably between 20 mm and 50 mm. if continuous fibres are used, these may have an average fibre length of more than 80 mm, for example more than 90 mm. The fibres may preferably be carbon fibres, aramid fibres or glass fibres. The fibres may be embedded in the form of random fibres and/or in a quasi-isotropic manner into the thermoset matrix material as such. A functional layer may have been provided, for example, in the form of a sheet moulding compound layer. Thus, any of the functional layers may take the form of a semifinished product. Preferably, each of the functional layers may have the same lateral extent, such that the functional layers may be arranged in mutually parallel layers in order thus to form the layer arrangement. It is also conceivable that the functional layers are arranged at an angle relative to one another. In other words, this means that an average direction of extent of the fibres of a functional layer may be arranged at a non-zero angle relative to the average direction of extent of the fibres of an adjacent functional layer. Since any functional layer may be formed by a fibre-reinforced thermoset matrix material, and each of these functional layers may therefore be as yet incompletely cured or as yet incompletely crosslinked but may each be merely partly crosslinked, the layer arrangement may also be pliable.

In a next step after the provision of the first semifinished product, a sealing compound is applied to a top side of the first semifinished product. A top side of the semifinished product may describe an outer face of the semifinished product, the area of which is several times greater than a circumferential edge area. More particularly, the sealing compound is applied to a predetermined deposition region. A predetermined deposition region may be a region disposed on the top side of the semifinished product. In addition, the deposition region may be arranged around a region or include a region that may be intended for an opening, for example. Such a predetermined deposition region may be of any shape. Advantageously, the deposition region may have a shape corresponding to the shape and/or extent and/or contact or passage area of a corresponding element provided in the assembly operation. Such a corresponding element may, for example, be a securing element. For example, the predetermined deposition region may have a closed ring structure. It is also conceivable that the predetermined deposition region constitutes a two-dimensional structure, i.e. a ring structure including its inner area. It is also conceivable that the ring structure is not closed, for example in the manner of an elongated strip. The predetermined deposition region may be arranged here on one or more edge faces of the semifinished product or spaced apart from the edge faces of the semifinished composite product. This application of the sealing compound to the first laminar semifinished product gives rise to a semifinished composite product.

The sealing compound here is formed from an elastomeric semifinished product. This elastomeric semifinished product is especially as yet incompletely crosslinked. The result of this may be that the elastomeric semifinished product can be formable. More preferably, the elastomeric semifinished product may include a base material, especially a rubber, and at least one crosslinking agent. The base material may comprise at least one of the following substances: ethylene-propylene-diene rubber (EPDM), ethylene-acrylate rubber (EAM), fluorocarbon rubber (FKM), acrylate rubber (ACM), acrylonitrile-butadiene rubber (NBR), hydrogenated nitrile rubber (HNBR), carboxyl nitrile rubber (XHNBR), natural rubber (NR), ethylene-vinyl acetate (EVA), chlorosulfonyl-polyethylene rubber (CSM), silicone rubber (VMQ, MVQ), fluorosilicone rubber (FVMQ, MFQ), chlorohydrin rubber (CO), epichlorohydrin rubber (ECO), polychloroprene rubber (CR), one-component polyurethane (PU) or a combination or blend of the aforementioned substances.

Examples of useful crosslinkers include sulfur or peroxides. The incompletely crosslinked elastomeric semifinished product may preferably not be dimensionally stable and/or even in dough-like form. Preferably, the incompletely crosslinked elastomeric semifinished product may take the form of a dough-like, plastically formable mass. It may thus be soft, in order thus to allow, in a particularly simple manner, plastic deformation on application of the incompletely crosslinked elastomeric semifinished product to the first semifinished product.

Finally, in a further step, the semifinished composite product is extrusion-formed to give the fully crosslinked fibre composite component having the elastomer seal. In the extrusion-forming operation, the semifinished composite product may be disposed atop a first press mould of a press apparatus. The press apparatus may have a second press mould. It is possible here for the first and second press moulds to determine the shaping of the fibre composite component having the elastomer seal. In extrusion-forming, the use of pressure and/or heat can result in crosslinking of the first semifinished product. In addition, crosslinking of the sealing compound to give the elastomer seal can take place essentially simultaneously. The result of the extrusion-forming operation is a fibre composite component having an elastomer seal.

In the first aspect of the invention, the method has the advantage that it is no longer necessary to separately fit and mount an elastomer seal on site. The method of the invention allows the elastomer seal to be prepared as early as during the production of the fibre composite component in a corresponding manner to the assembly situation. A fibre composite component having an elastomer seal that has been produced by the method according to the invention thus merely has to be mounted on site. This dispenses with time-consuming fitting of the seal elements on site. This results in a distinctly reduced assembly time. Particularly in the field of assembly in fuel tanks, this in turn eliminates the logistical bottleneck that exists in the prior art. Thus, the present invention is helpful in the optimization of operating cycles, saves costs and helps to release personnel resources that were tied up beforehand and hence to achieve higher productivity in the production cycle. Furthermore, it is possible to assure in a predictable manner that the elastomer seal will sit at the correct position to assure sealing.

In an advantageous embodiment, in the first aspect of the invention, the first semifinished product consists of the fibres preimpregnated with the first thermoset, incompletely crosslinked matrix material. Fibres impregnated in this way are known in the prior art. Thus, the handling thereof, especially the technical methods necessary for the purpose, do not constitute any problems. Moreover, semifinished products of this kind are inexpensive to procure. This likewise lowers the overall costs, for example of an aircraft into which a fibre composite component produced from these semifinished products is installed. Furthermore, it is thus possible to produce a monolithic fibre composite component.

In an advantageous embodiment, in the first aspect of the invention, the first semifinished product has a first outer layer, a second outer layer and a core layer arranged between the first outer layer and the second outer layer, where the first outer layer and the second outer layer each consist of the fibres preimpregnated with the first thermoset, incompletely crosslinked matrix material, and where the core layer has a multitude of voids.

Such a layer structure may typically have a high stiffness. It is possible here for the first and second outer layers, owing to their separation from one another owing to the core layer, to give a high area moment of inertia and hence high flexural stiffness. At the same time, the core layer may generate shear rigidity. The mechanical properties of the semifinished product can be adjusted by means of different core layers. Preferably, the core layer may take the form of a solid foam. A core layer composed of a solid foam may give low weight owing to the multitude of closed voids. At the same time, the foam may achieve high strength and flexural stiffness.

Preferably, the two outer layers with the core layer disposed in between may form a sandwich structure. Such a sandwich layer structure may be achieved, for example, by means of a core layer with a honeycomb core. A honeycomb core may give high strength with simultaneously low weight owing to the arrangement of the individual honeycombs.

It is also conceivable that the core layer has a heat shield. A heat shield may be provided, for example, in the form of a metallic material, for example in the form of a foil or thin plies.

In practice, it is by no means a rare demand for a component to be mountable particularly simply, rapidly and easily. However, a fibre composite component having a low surface weight as normal cannot completely meet these demands under some circumstances. This is especially true with regard to the sealing of an opening in the fibre composite component. If, however, the fibre composite component has an elastomer seal secured thereto, as is the case in accordance with an aspect of the invention, slippage of the seal is firstly effectively prevented. Furthermore, the seal is predictably arranged at the correct site, namely preferably in an annular manner around the respective opening. Faults in the mounting of such a fibre composite component are thus reduced. At the same time, the rate of mounting is increased, which leads to lower assembly costs.

In an advantageous embodiment, in the first aspect of the invention, an opening through the fibre composite component is established for the elastomer seal, such that the elastomer seal surrounds the opening at the edge in an annular manner.

By virtue of the openings, it is possible to conduct securing elements for securing of the fibre composite component, for example, through the fibre composite component. The securing elements may include or may be flanges, for example. The flanges may extend over the region of the opening in the fibre composite component. On assembly, these regions can engage with the elastomer seal disposed around the edge of the opening in an annular manner. This can give rise to a sealing transition between the securing element and the fibre composite component.

By virtue of the provision of the elastomer seal around the edge of an opening in an annular manner, sealed securing of the fibre composite component with the aid of a securing element is thus enabled.

In an advantageous embodiment, in the first aspect of the invention, the opening is established after step c). The opening can especially be established subsequently to step c).

For example, the opening can be removed mechanically from the fibre composite component. The mechanical removal can be effected by means of machining, sawing, cutting, die-cutting and/or drilling. Establishing the openings after the extrusion-forming of the semifinished composite product in step c) can have the advantage that it can be conducted rapidly and inexpensively.

In an advantageous embodiment, in the first aspect of the invention, the opening is established during step c). Thus, during the extrusion-forming of the semifinished composite product, it is possible to leave regions clear in which no semifinished composite product is being disposed. For example, elements corresponding to the opening may be provided in the first and/or second press mould. These corresponding elements can interact on joining of the first and second press moulds and hence displace any semifinished composite product disposed beforehand.

Provision of the openings during step c) can have the advantage that material is saved in the form of the semifinished composite product. In addition, for example, it is possible to reuse a mould that takes account of the opening. Both can lead to an accelerated process for production of the fibre composite component according to the invention with an elastomer seal.

In an advantageous embodiment, in the first aspect of the invention, each elastomer seal in step c) takes the form of an annular elastomer seal.

It is possible here for an annular mould to describe a closed and/or circumferential line. This line may have a circular form, but is not restricted thereto. This can have the following advantage: in the securing of the fibre composite component to a securing element, a securing element may be disposed in the opening having the elastomer seal. It is possible here for a flange of the securing element to engage with the elastomer seal of the fibre composite component. An annular shape of the elastomer seal can ensure that the elastomer seal completely surrounds and hence completely seals the opening.

In an advantageous embodiment, in the first aspect of the invention, each deposition region is configured as an annular deposition region.

It is thus possible to ensure that the elastomer seal produced in step c) is an annular elastomer seal that fully surrounds and hence seals the opening on engagement, for example, with a flange of a securing element. The annular deposition region here may have any circumferential form. More particularly, the deposition region may have a circular, oval, rectangular or square form. In other words, the deposition region may also have corners. It is also possible that the deposition region is configured without corners. The configuration of the deposition region as an annular deposition region can avoid subsequent removal of excess elastomer seal after step c). This can save material costs, and the production time for the fibre composite component having an elastomer seal can be shortened.

In an advantageous embodiment, in the first aspect of the invention, a first press mould and a second press mould are used for the extrusion-forming operation, wherein the first press mould has a first press side configured for shaping of a front side of the fibre composite component, wherein the first press side has a first mould section that projects into the first press mould, such that the first mould section forms a first cavity open toward the first press side, and wherein the sealing compound is applied in step b) in such a way that the sealing compound, in the extrusion-forming operation in step c), flows into and fills the first cavity.

In other words, it is possible to use a first press mould and a second press mould that may be part of an extrusion apparatus in the extrusion-forming operation. The first and second press moulds may be movable relative to one another between a closed position in which the first and second press moulds can enclose an accommodation space, and an open position in which the accommodation space may be open with respect to the environment. It is possible here for part of the accommodation space to be bounded by the first press side of the first press mould and the second press side of the second press mould. Preferably, the first and/or second press side may be configured such that the fibres are arranged in a very optimal manner with respect to an expected distribution of load on the fibre composite component.

The first mould section of the first press mould can project into the first press mould. Thus, the first mould section can form a first cavity that can form part of the accommodation space. The first mould section may have an outline that can be designed to shape a section of the fibre composite component having the elastomer seal to be produced. More particularly, the mould section or the first cavity formed thereby may be set up to accommodate and to form the sealing compound before and/or during the extrusion-forming operation. The elastomer seal may have been formed on the fibre composite component in this way. Preferably, the fibre composite component may have multiple elastomer seals. For this purpose, a corresponding first cavity may have been provided for each elastomer seal. This can avoid exchange of material between the first cavities during the extrusion-forming operation.

For the extrusion-forming cycle, the press moulds may be run in the open position. Furthermore, it may be preferable for the extrusion-forming operation that the semifinished composite product is inserted into the accommodation space. For this purpose, the semifinished composite product, for exact positioning, may preferably be disposed on and aligned with respect to the first press mould. Further preferably, the semifinished composite product may be aligned with respect to the first cavity. Finally, for the extrusion-forming operation, the press moulds may be run in the closed position, such that the semifinished composite product can be subjected to a or the process pressure, in which case the first semifinished product can be heated, for example, in such a way that the semifinished composite product can be subjected to a temperature at which the semifinished composite product can give rise to the fibre composite component.

The use of a first and second press mould with a first cavity provided in the first press mould can have the advantage that the semifinished composite product can be exactly aligned with respect to the first cavity and hence to the sealing compound to be crosslinked. This can achieve high accuracy of positioning of the elastomer seal relative to the fibre composite component.

In an advantageous embodiment, in the first aspect of the invention, each section of the first semifinished product bounded on the top side by a deposition region is reinforced by further fibres and/or metallic anchoring elements.

The elastomer seal is disposed in the deposition region on the fibre composite component. The section that forms the deposition region can be reinforced such that the forces that additionally act by virtue of the seal formed can be better distributed. The reinforcement with fibres and/or metal can extend in an annular manner around the respective opening.

The provision of reinforcing elements in the form of additional fibres and/or metallic elements can improve mechanical stability in the region of the elastomer seal of the fibre composite component. As a result, it is possible to better absorb any forces that occur.

In an advantageous embodiment, in the first aspect of the invention, a cohesive bond forms in step c) between the fibre composite component and the elastomer seal. A cohesive bond can ensure a bond that can be parted only with difficulty between the fibre composite component and the elastomer seal. This can achieve a seamless and mechanically robust transition between the elastomer seal and the fibre composite component. The consequence may be an optimal seal between the fibre composite component and the elastomer seal.

In an advantageous embodiment, in the first aspect of the invention, a depression has been formed on the top side of each deposition region of the first semifinished product, wherein the sealing compound in step c) is introduced at least partly into the respective depression.

This gives rise, in step c), to a both cohesive and form-fitting bond between the elastomer seal and the fibre composite component. The combination of cohesive and form-fitting bond can improve the mechanical properties of the transition between the elastomer seal and the fibre composite component. For example, by virtue of the combination of the two types of bond, it is possible to better absorb shear forces. Shear forces can occur, for example, between a securing element and the fibre composite component. This can reduce the risk of mechanical failure of the seal transition between the elastomer seal and the fibre composite component.

In an advantageous embodiment, in the first aspect of the invention, the first semifinished product has a section with an integrated heat shield. The heat shield may be disposed here on an outer face of the semifinished product. Alternatively, the heat shield may be accommodated within the semifinished product. If the semifinished product has a layer structure or sandwich structure, the core material may have a heat shield. It is also conceivable that the heat shield may be accommodated within or atop one of the outer layers. The heat shield may be executed, for example, as a metallic material, for example in sheet form, or as a foil. However, it is also conceivable that the heat shield may include a ceramic material or a combination of ceramic material and metallic material. Preferably, the first semifinished product may have multiple sections each having an integrated heat shield.

The provision of a heat shield allows thermal shielding of thermally sensitive regions disposed adjacent to the heat shield of a mounted fibre composite component. In addition, the provision of a heat shield can reduce the assembly time on site since there is no need to additionally mount a heat shield.

In addition, a second aspect of the invention, relates to a fibre composite component having an elastomer seal. The fibre composite component according to an embodiment of the invention has an elastomer seal disposed on a top side of the fibre composite component at the edge in an annular manner around an opening through the fibre composite component. The fibre composite component and the elastomer seal here are cohesively bonded to one another by a common extrusion-forming operation.

Such a fibre composite component can have the advantage that, in the event of engagement of the elastomer seal, for example, with a flange of a securing element, it can provide a closed seal in the region of the opening. In addition, such a fibre composite component can be mounted at the assembly site within a short time. More particularly, it is possible to dispense with manual adaptation of sealing elements prior to the mounting of the fibre composite component having the elastomer seal. This can lead to a distinct reduction in the assembly time and can help, for example, to avoid the bottleneck in the mounting of seals in the region of fuel tanks of aircraft.

In an advantageous embodiment, in the second aspect of the invention, the fibre composite component has been formed from a thermoset material admixed with fibres, and the elastomer of the elastomer seal has been crosslinked with the thermoset material at the bond to the fibre composite component.

In other words, the elastomer seal may form a cohesive bond with the fibre composite component. Such a bond may give optimal sealing properties.

### BRIEF DESCRIPTION OF THE DRAWINGS

Further features, advantages and possible uses of the present invention will be apparent from the description of the working examples which follows and the figures. All features that are described and/or represented in images here, independently and in any combination, form the subject-matter of the invention independently of their composition in the individual claims or their dependency references. In the figures, identical reference numerals still represent identical or similar objects.

The figures show:

FIG. 1 a schematic flow diagram of one configuration variant of the method;

FIG. 2 a flow diagram of a further advantageous configuration of the method;

FIGS. 3a-3e the schematic cycle from the use of the first laminar semifinished product and the sealing compound as far as the extrusion-forming to produce the fibre composite component having an elastomer seal;

FIG. 4 a schematic cross-sectional diagram of a configuration variant of the fibre composite component having an elastomer seal;

FIG. 5 a schematic diagram of a fibre composite component having a securing element that has been guided through an opening in the fibre composite component such that the elastomer seal has a sealing effect between the fibre composite component and the securing element;

FIG. 6 a further configuration of a fibre composite component having an elastomer seal in a schematic cross-sectional view; and

FIG. 7 a further advantageous configuration of a fibre composite component having an opening in which a securing element has been inserted such that the elastomer seal has a sealing effect between the securing element and the fibre composite component.

### DETAILED DESCRIPTION

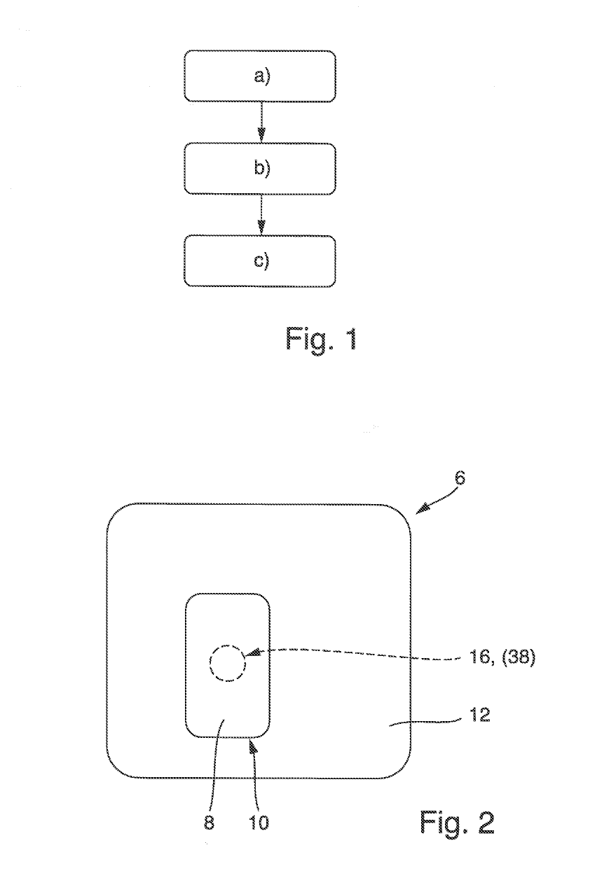

FIG. 1 shows a schematic flow diagram for the method of producing a fibre composite component 2 having an elastomer seal 4. In a first step a) of the method, the provision of a first laminar semifinished product 6 having a first thermoset, incompletely crosslinked matrix material is envisaged. In a second step b) of the method, application of a sealing compound 8 to a predetermined region 10 of a top side 12 of the first semifinished product 6 is envisaged, so as to give rise to a semifinished composite product 14 composed of the first semifinished product 6 and the sealing compound 8 applied, where the sealing compound 8 has been formed by an elastomeric semifinished product. In a third step c) of the method, extrusion-forming of the semifinished composite product 14 to form the fully crosslinked fibre composite component having the elastomer seal 4 is envisaged, wherein the fibre composite component 2 forms as a result of crosslinking of the first semifinished product 6 and the elastomer seal 4 through crosslinking of the sealing compound 8.

One example of a first laminar semifinished product 6, which is also referred to hereinafter as first semifinished product 6, is shown in schematic form in FIG. 2. The first semifinished product 6 is shown here from the top side 12. Laminar semifinished products 6 of this kind are often used to produce larger-area fibre composite components 2. However, it is by no means a rare requirement for fibre composite components 2 of this kind to have to be bonded to other components. For this purpose, the fibre composite component 2 may have an opening 38. By means of this opening 38, the fibre composite component 2 can be bonded to another component. If the fibre composite component 2 is additionally used in a region where there is to be no exchange of gas and/or fluid with the environment through the aforementioned opening 38, a seal suitable for the purpose is required in the region of the opening 38. In practice, however, a task that has frequently been faced in this case is that of disposing the seal with maximum precision and predictability in such a way that the opening 38 is closed on securing of the fibre composite component 2. This can especially be assured in that the seal has been disposed with particular precision and accuracy around the opening 38 beforehand. But even if this is the case at one juncture, what can happen in the course of assembly is that such a seal can slip again. Thus, further measures are required to assure the predictable arrangement of the seal in the region of the opening 38, such that the sealing effect is indeed achieved at a later stage.

FIG. 2 shows the first semifinished product 6 in schematic form in a top view. Therefore, FIG. 2 also indicates the opening 16 provided at a later stage for the fibre composite component 2 with a dotted line. It thus identifies the region of the first semifinished product 6 where, at a later stage, in the extrusion-forming operation, the opening 38 is formed in the semifinished fibre composite product 2. Alternatively, it may be the case that the opening 38 is established subsequently in the corresponding region, for example by drilling or machining.

In order to achieve a very good sealing effect, a seal should be disposed around the circumference of the opening 16 provided. It is therefore the case that there is a predetermined deposition region 10 of the top side 12 of the first semifinished product 6 where a sealing compound 8 is applied. On application, the sealing compound 8 may also cover the region of the opening 16. Nevertheless, the sealing compound (8) (also) covers the region of the opening 16 in a circumferential or annular manner. In other words, the sealing compound 8 is in annular form around the opening 16 envisaged on the top side 12 of the semifinished product 6.

The first semifinished product 6 includes a thermoset, incompletely crosslinked matrix material in which fibres have been distributed. This can be formed in that fibres are preimpregnated with the matrix material mentioned. In addition, the fibres preimpregnated with the incompletely crosslinked, thermoset matrix material have been arranged in laminar form. This may preferably be what is called a sheet moulding compound (SMC). However, it is also possible that the first semifinished product 6 has at least one laminar outer layer formed by fibres preimpregnated with the first thermoset, incompletely crosslinked matrix material. In other words, the first outer layer may be formed by a sheet moulding compound.

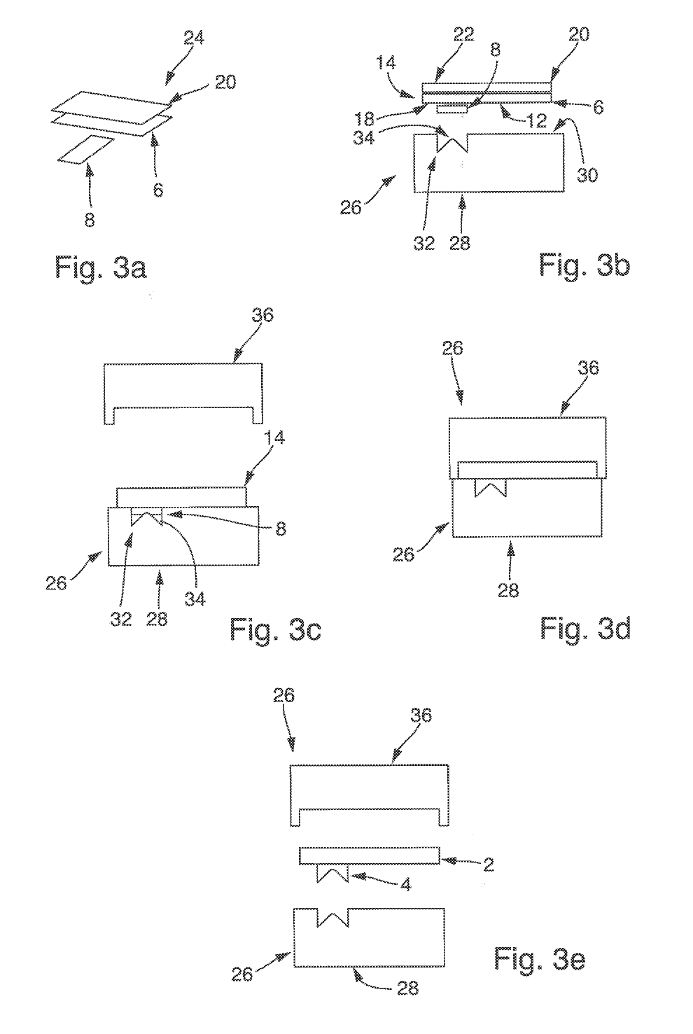

FIG. 3a shows a first laminar semifinished product 6. This is preferably a first outer layer of a semifinished sandwich product 24. The first semifinished product 6 here takes the form of a sheet moulding compound. As shown in schematic form in FIG. 3a, the semifinished product 24 in sandwich form includes the first laminar semifinished product 6 and a second laminar semifinished product 20 that are arranged one on top of the other, especially parallel to one another. The first semifinished product 6 may thus form a first outer layer 18 of the semifinished product 24 in sandwich form and the second laminar semifinished product 20 a second outer layer 22 of the semifinished product 24 in sandwich form. Between these is disposed a core layer (not shown). In principle, it is also possible to dispense with this core layer. If the core layer is provided, this may be a porous core layer and/or a core layer in foam form. More particularly, it is a feature of the core layer that it has a multitude of voids.

As indicated in FIG. 3a, the sealing compound 8 is applied to the predetermined deposition region 10 on the top side 12 of the first semifinished product 6, which is shown in schematic form in FIG. 2. This gives rise to a semifinished composite product 14 composed of the first semifinished product 6 and the sealing compound 8 applied. This is in turn shown in schematic form in FIG. 3b. It is also apparent from FIG. 3b that the first semifinished product 6 has also been bonded at least indirectly to the second laminar semifinished product 20, especially via the core layer (not shown). In this case, the second laminar semifinished product 20 also forms part of the semifinished composite product 14. The sealing compound 8 is formed by an elastomeric semifinished product.

For the extrusion-forming of the semifinished composite product 14 to give the fully crosslinked fibre composite component 2 having the elastomer seal 4, it is possible to use, for example, an extrusion-forming apparatus 26 as shown schematically by way of example in FIGS. 3b to 3e.

FIG. 3b shows a schematic of a first press mould 28 of the extrusion-forming apparatus 26. The first press mould 28 has a first press side 30. The first press side 30 has preferably been configured for shaping of a front side of the fibre composite component 2 to be produced. The first press side 30 has a first mould section 32 that extends into the first press mould 28, such that the first mould section 32 forms a first cavity 34 open to the first press side 30.

As shown in schematic form in FIG. 3b, the sealing compound 8 has been applied on the top side 12 of the first semifinished product 6 in such a way that the sealing compound 8, when the semifinished composite product 14 is disposed in an accommodation space of the extrusion-forming apparatus 26, is disposed opposite the first cavity 34. If the semifinished composite product 14, as shown in schematic form in FIG. 3c, is placed onto the first press side 30, the sealing compound 8 projects at least partly into the first cavity 34. It is preferably the case here that the sealing compound 8 is applied in such a way, especially with regard to the application to the predetermined deposition region 10 and/or with regard to the amount of the sealing compound 8, such that the sealing compound 8 flows into and fills the cavity 34 in an extrusion-forming operation. This prevents the first semifinished product 6 and/or second semifinished product 20 from being affected with regard to their shape by the first cavity 34. Instead, the first cavity 34 serves exclusively to shape the sealing compound 8 or the elastomer seal 4 to be produced therefrom.

For the extrusion-forming operation, the second press mould 36 already shown in FIG. 3c is moved in the direction of the first press mould 28 such that the semifinished composite product 14 is extrusion-formed under pressure and/or at high temperature, such that the sealing compound 8 gives rise to an elastomer seal 4 through crosslinking of the sealing compound. In the extrusion-forming operation, in addition, the first semifinished product 6 and, if appropriate, any further semifinished thermoset product, such as the second semifinished product 20 as well are crosslinked. This may also be correspondingly applicable to the core layer. Thus, the fibre composite component 2 is formed at least from the first semifinished product 6, preferably from the first semifinished product 6, the second semifinished product 20 and, if appropriate, the core layer. In the extrusion-forming operation, the sealing compound 8 and the thermoset matrix material are then preferably crosslinked simultaneously, such that the extrusion-forming operation preferably gives rise to a cohesive bond between the fibre composite component 2 and the elastomer seal 4.

After the extrusion-forming operation, the second press mould 36 can be removed again from the first press mould 28, such that the fibre composite component 2 having the elastomer seal 4 that has now been produced can be removed from the accommodation space of the extrusion-forming apparatus 26.

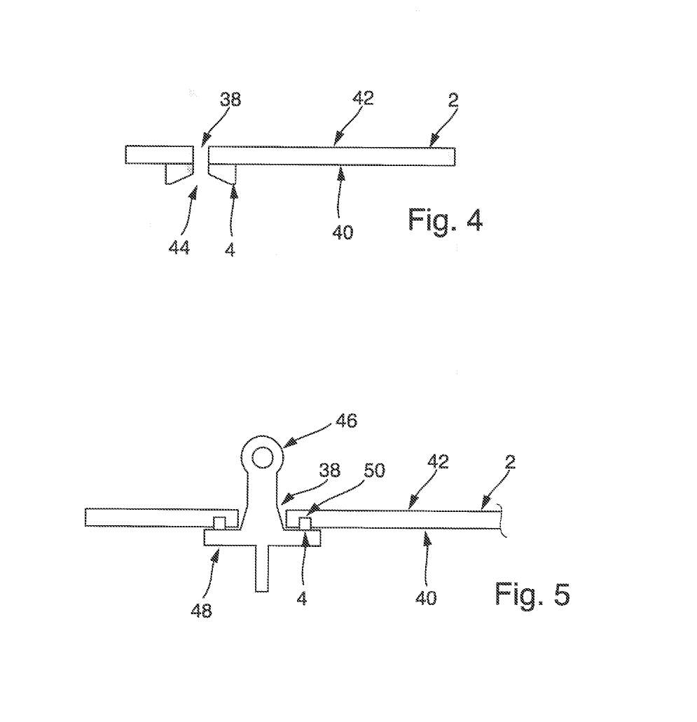

FIG. 4 shows the fibre composite component 2 having the elastomer seal 4 in a schematic cross-sectional view. This is an advantageous configuration. The fibre composite component 2 has an opening 38 that extends through the fibre composite component 2. The opening 38 extends from a first top side 40 of the fibre composite component 2 to an opposite top side 42 of the fibre composite component 2. The opening 38 of the fibre composite component 2 may already have been produced during the extrusion-forming operation. The extrusion-forming apparatus 26 may have been designed correspondingly for the purpose. For instance, a ram section may have been assigned to the first press mould 28 and/or second press mould 36, which establishes the opening 38 in the fibre composite component 2 when the two press moulds 28, 36 are moved into the closed position. The elastomer seal 4 extends around the circumference, especially in an annular manner, around the edge at the first top side 40 of the fibre composite component 2. It is preferably the case here that the elastomer seal 4 likewise has an opening section 44 flush with the opening 38. Thus, the elastomer seal 4 may extend directly up to the edge of the opening 38 of the fibre composite component 2. This gives the advantage that a securing element 46 which is guided through the opening 38 of the fibre composite component 2 in order to secure the fibre composite component 2 can be sealed with respect to the fibre composite component 2 in a particularly reliable and effective manner by means of the elastomer seal 4.

The opening section 44 of the elastomer seal 4 may have been produced simultaneously with the opening 38 of the fibre composite component 2 during the extrusion-forming operation. In principle, however, it is also possible that the opening 38 and the opening section 44 of the elastomer seal 4 are established subsequently. For instance, this may be formed by a corresponding drilling and/or machining operation. In other words, in a further step of the method, the opening 38 and/or the opening section 44 in the elastomer seal 4 may be produced subsequently by drilling or machining.

FIG. 5 shows the fibre composite component 2 with the elastomer seal 4 in such a schematic form as can be employed in practice. For this purpose, a securing element 46 fits through the opening 38, such that the section of the securing element 46 that projects through the opening 38 beyond the second top side 42 is suitable for mounting on a further component, such that the fibre composite component 2 can be secured via the securing element 46, especially to the further component. The securing element 46 has a flange section 48 in disc form that extends in transverse direction. The flange section 48 extends in transverse direction beyond the edge of the opening 38, such that the flange section 48 reaches through the fibre composite component 2 at the first top side 40. Therefore, the flange section 48 firstly presses against the elastomer seal 4 which is now disposed between the fibre composite component 2 and the flange section 48. The flange section 48 in disc form and the elastomer seal 4 that extends around the circumference of the opening 38 therefore ensure that a sealing effect between the flange section 48 and the fibre composite component 2 is achieved. As elucidated above, in the extrusion-forming operation, cohesive bonding preferably takes place between the elastomer seal 4 and the fibre composite component 2. In the securing of the fibre composite component 2 by means of the securing element 46 thereof, it is therefore possible to ensure that the elastomer seal 4 does not slip unintentionally.

It has therefore been found to be advantageous when a depression on the first top side 12 of the first semifinished product 6 has been provided such that it is disposed in the region of the deposition region 10, and preferably around the circumference of the opening 16 or 38 to be provided. Correspondingly, for this purpose, the fibre composite component 2 therefore also has a depression 50 on the first top side 40 that extends in an annular manner around the opening 38. The depression 50 and the elastomer seal 4 may be designed with respect to one another such that the elastomer seal 4 can be compressed such that the elastomer seal 4 is disposed completely in the depression 50, as shown in schematic form, for example, in FIG. 5, when the securing element 6 has been pressed against the fibre composite component 2 in the longitudinal axial direction of the opening 38.

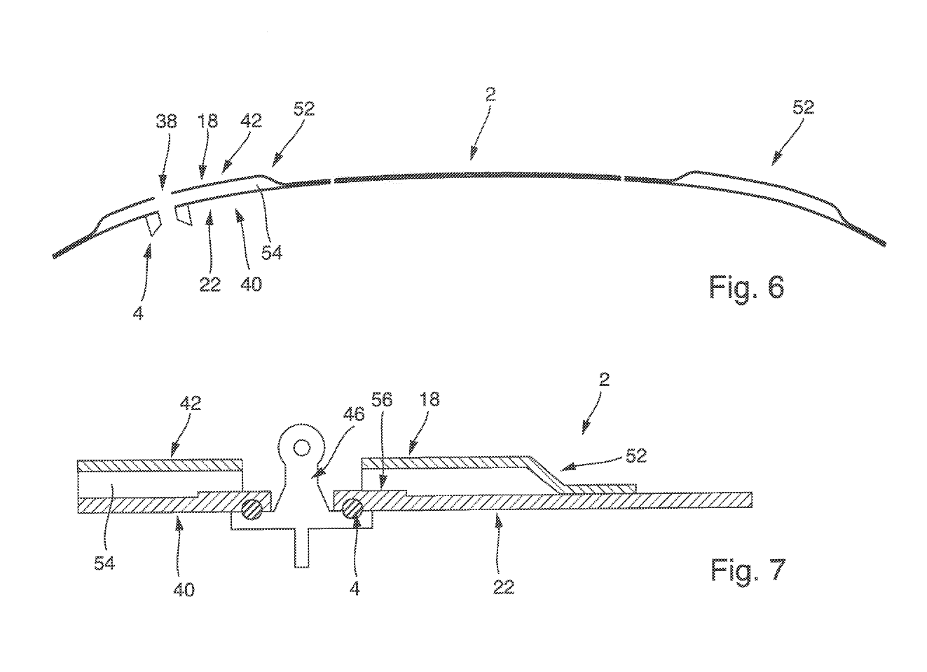

FIG. 6 shows the fibre composite component 2 having the elastomer seal 4 in a further advantageous configuration in a schematic cross-sectional view. A preferred feature here of the fibre composite component 2 is that at least one section 52 is or, as shown in FIG. 2, multiple sections 52 are formed in a multilayer sandwich arrangement. Such a section 52 may have a core layer 54 covered by an outer layer on each of the opposite outer faces. The lower outer layer is formed here by the crosslinked first laminar semifinished product 6 or the first outer layer 18. The opposite second layer is formed by the crosslinked second laminar semifinished product 20 or the second outer layer 22. In this region too, an opening 38 may be provided, in which case a correspondingly formed elastomer seal 4 that extends in an annular manner around the edge of the opening 38 is disposed on the first top side 40.

From FIG. 7 is possible to infer further advantageous details which may be provided in relation to the fibre composite component 2 or the sandwich section 52 of the fibre composite component 2. In principle, the elucidations which follow, however, are also applicable to the construction of the fibre composite component 2 with just one layer, and so the fibre composite component 2 may also take the form of monolithic bodies.

It is apparent from FIG. 7 by way of example that, for the provision of the first laminar semifinished product 6, a region around the envisaged opening 38 in the first laminar semifinished product 6 may have reinforcing elements, for example a higher amount of fibres impregnated with the incompletely crosslinked matrix material and/or metallic reinforcing elements. These may especially be disposed on the reverse side from the deposition region 10 and/or in the deposition region 10 on the top side 12 of the first laminar semifinished product 6. If such a first laminar semifinished product 6 is used to produce the fibre composite component 2, this results in a reinforced section 56 as shown in schematic form for the fibre composite component 2 in FIG. 7. This reinforcement section 56 preferably extends in an annular and/or circumferential manner around the opening 38. The reinforcing section may be provided by means of crosslinked matrix material with introduced fibres and/or with at least one metal element. Forces that act on the fibre composite component 2 in normal direction from the securing element 46, for example, can thus be passed onward particularly efficiently to adjacent regions of the fibre composite component 2.

It should additionally be pointed out that “having” does not rule out any other elements or steps and “a” or “one” does not exclude a multitude. It should also be pointed out that features that have been described with reference to one of the above working examples can also be used in combination with other features of other above-described working examples.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of producing a fibre composite component having an elastomer seal, comprising:
a) providing a first, laminar semifinished product having fibres preimpregnated with a first thermoset, incompletely crosslinked matrix material;
b) applying a sealing compound to a predetermined deposition region at a top side of the first semifinished product so as to form a semifinished composite product composed of the first semifinished product and the sealing compound applied, the sealing compound being formed by an elastomeric semifinished product; and
c) extrusion-forming the semifinished composite product to give the fully crosslinked fibre composite component having the elastomer seal, wherein the fibre composite component results from crosslinking of the first semifinished product, and the elastomer seal from crosslinking of the sealing compound.

2. The method according to claim 1, wherein the first semifinished product includes the fibres preimpregnated with the first thermoset, incompletely crosslinked matrix material.

3. The method according to claim 1, wherein
the first semifinished product has a first outer layer, a second outer layer and a core layer arranged between the first outer layer and the second outer layer,
the first outer layer and the second outer layer each includes the fibres preimpregnated with the first thermoset, incompletely crosslinked matrix material, and
the core layer has a multitude of voids.

4. The method according to claim 1, wherein an opening through the fibre composite component is established for the elastomer seal, such that the elastomer seal surrounds the opening at the edge in an annular manner.

5. The method according to claim 4, wherein the opening is established after step c).

6. The method according to claim 4, wherein the opening is established during step c).

7. The method according to claim 1, wherein each elastomer seal in step c) takes the form of an annular elastomer seal.

8. The method according to claim 1, wherein each deposition region is configured as an annular deposition region.

9. The method according to claim 1, wherein a first press mould and a second press mould are used for the extrusion-forming operation,
wherein the first press mould has a first press side configured for shaping of a front side of the fibre composite component,
wherein the first press side has a first mould section projecting into the first press mould, such that the first mould section forms a first cavity open toward the first press side, and
wherein the sealing compound is applied in step b) in such a way that the sealing compound, in the extrusion-forming operation in step c), flows into and fills the first cavity.

10. The method according to claim 1, wherein each section of the first semifinished product bounded on the top side by a deposition region is reinforced by further fibres and/or metallic anchoring elements.

11. The method according to claim 1, wherein a cohesive bond forms in step c) between the fibre composite component and the elastomer seal.

12. The method according to claim 1, wherein a depression has been formed on the top side of each deposition region of the first semifinished product, and
wherein the sealing compound in step c) is introduced at least partly into the respective depression.

13. The method according to claim 1, wherein the first semifinished product has a section with an integrated heat shield.

14. A fibre composite component having an elastomer seal disposed on a top side of the fibre composite component at the edge in an annular manner around an opening through the fibre composite component, wherein the fibre composite component and the elastomer seal are cohesively bonded to one another by a common extrusion-forming operation.

15. The fibre composite component according to claim 14, wherein the fibre composite component has been formed from a thermoset material admixed with fibres, and the elastomer of the elastomer seal has been crosslinked with the thermoset material at the bond to the fibre composite component.
